(19) United States
(12) Patent Application Publication
(10) Pub. No.: US 2025/0274201 A1
(43) Pub. Date: Aug. 28, 2025

(54) METHOD AND ARRANGEMENT FOR DETERMINING AT LEAST ONE DISTANCE BETWEEN ANTENNAS

(71) Applicant: KOHERENT OY, Vantaa (FI)

(72) Inventors: Kari LEPPÄNEN, Helsinki (FI); Jussi SALMI, Haarajoki (FI); Niko VÄISÄNEN, Kerava (FI)

(73) Assignee: KOHERENT OY, Vantaa (FI)

(21) Appl. No.: 18/855,442

(22) PCT Filed: May 22, 2023
(86) PCT No.: PCT/FI2023/050284

§ 371 Date: Oct. 9, 2024

(30) Foreign Application Priority Data
May 25, 2022 (FI) 20225455

(51) Int. Cl. H04B 17/19; H04B 17/10; H04W 64/00

(52) U.S. Cl. CPC H04B 17/19; H04B 17/104; H04W 64/003

(57) ABSTRACT

A method for determining at least one distance between pairs of antennas, the method including performing self-measurements and first two-way transmissions at first time intervals, first one-way transmissions at second time intervals, second two-way transmissions at third time intervals, and second one-way transmissions at fourth time intervals. The method also includes determining phase information based on the performed transmissions and determining distance information regarding the at least one distance.

### TECHNICAL FIELD OF THE INVENTION

The invention relates to radio communication and distance measurements in general. More specifically, the invention relates to determining at least one distance between pairs of antennas based on a plurality of transmissions carried out at selected time intervals.

### BACKGROUND OF THE INVENTION

Distance measurements in general may be utilized in a variety of useful applications. For instance, distances between one or more transmitter devices and receiver devices may be determined and used for positioning purposes. Methods involving measurement of phases of received signals are used when high positioning accuracy is needed, such as in Real Time Kinematic (RTK) Global Navigation Satellite Systems (GNSS).

Traditional wireless positioning methods, such as GNSS or long range navigation (LORAN) utilize only downlink or one-way transmissions. Signals are thus transmitted only in one direction, from transmitters (e.g. satellites) to receivers (for instance terrestrial mobile units). To reach high accuracy, such carrier phase techniques require the measurement of relative phase between signals received from a plurality of different transmitters and additionally, the integer ambiguity (IA) problem must be solved (e.g. RTK in GNSS). Rapid solution (such as in seconds as opposed to minutes) of the IA problem in RTK GNSS requires unimpeded simultaneous reception from a large number of transmitters (satellites). This is not generally possible in fully terrestrial measurement systems, as it would require tens of pseudolites/access points/base stations to be visible in line-of-sight simultaneously. Also, in the satellite-based solutions, obstacles in sky view and radio reflections, originating from e.g. from buildings in large cities, also significantly lower the accuracy of measurements and any further information determined therefrom.

The most accurate radio distance measurements are still typically based on carrier phase techniques. Yet, to measure the distance directly between any two radio units (a radio link) using such techniques requires either that the radio units are fully phase coherent a-priori, which may be expensive to arrange especially if cables are needed, or with usage of two-way transmissions. Here, a distance may be evaluated between a pair of radio units without a-priori phase synchronization, by each sending a signal having corresponding frequency that is received at the other radio unit.

Two-way transmissions may enable achieving phase-based position determination with a very low number of infra-stations, unlike in e.g. GNSS.

Yet, a drawback of utilizing two-way transmissions is that it is problematic in view of resources and scalability. In worst case, solutions involving two-way transmissions require two individual wideband transmissions for each link. This also means that all units, e.g. also moving units that are to be tracked or positioned, must transmit and receive signals repeatedly for accurate positioning determination.

Full measurement data regarding signals is required from both participating units in the two-way phase transmission methods. This may be problematic for a mobile unit if it should carry out measurements regarding a multitude of fast-changing links and related transmissions from many antennas. A large amount of information would be required to be frequently transmitted over a wireless link to a distance calculation unit. Furthermore, breaks in data communication may increase latency of e.g. positioning.

It would be desirable to provide a solution for accurately and efficiently determining distances in terrestrial systems that would require less resources and would not require two-way measurement over all the measured links.

### SUMMARY OF THE INVENTION

An objective of the invention is to alleviate at least some of the problems in the prior art. The objective is achieved with various embodiments of a method for determining distance and related arrangements for determining distance. Determining a distance may refer to determining a numerical value for a distance or determining one or more variables that are indicative of the distance, which may be utilized to calculate a numerical value for a distance.

According to a first aspect of the present invention, a method is provided for determining at least one distance between pairs of antennas, each antenna relating to a radio unit, the method comprising
performing self-measurements via at least a portion of the antennas at selected first time intervals, and determining self-measurement phase information for each antenna participating in the self-measurements,
performing first two-way transmissions between a first plurality of the pairs of antennas at the first time intervals, and determining first two-way phase information for each pair of antennas participating in the first two-way transmissions,
obtaining information regarding clock rates and Doppler frequencies for the first plurality of pairs of antennas,
determining antenna branch phase response data for the antennas of the first plurality of pairs of antennas and absolute clock offset data between the radio units associated with the first plurality of pairs of antennas using the self-measurement phase information, the first two-way phase information, and the information regarding clock rates and Doppler frequencies,
performing first one-way transmissions between a second plurality of pairs of antennas at selected second time intervals, and determining first one-way phase information for each pair of antennas participating in the first one-way transmissions,
determining distance information between the second plurality of pairs of antennas based on the determined first one-way phase information, antenna branch phase response data, and the absolute clock offset data,
performing second two-way transmissions between a third plurality of the pairs of antennas at selected third time intervals, and determining second two-way phase information for each pair of antennas participating in the second two-way transmissions,
tracking the clock offset changes between the radio units based on the second two-way phase information and the information regarding clock rates and Doppler frequencies,
performing second one-way transmissions between the second plurality of pairs of antennas at selected fourth time intervals, and determining one-way phase information for each pair of antennas participating in the second one-way transmissions, and
updating the distance information between the second plurality of pairs of antennas based on the determined second one-way phase information, the tracked clock offset changes and the antenna branch phase response data.

The invention also provides an arrangement for determining at least one distance between pairs of antennas, the arrangement comprising at least one processor and at least two radio units, each associated with at least one antenna, wherein the arrangement is configured to:
perform self-measurements via at least a portion of the antennas at selected first time intervals, and determine self-measurement phase information for each antenna participating in the self-measurements,
perform first two-way transmissions between a first plurality of the pairs of antennas at the first time intervals, and determine first two-way phase information for each pair of antennas participating in the first two-way transmissions,
obtain information regarding clock rates and Doppler frequencies for the first plurality of pairs of antennas,
determine antenna branch phase response data for the antennas of the first plurality of pairs of antennas and absolute clock offset data between the radio units associated with the first plurality of pairs of antennas using the self-measurement phase information, the first two-way phase information, and the information regarding clock rates and Doppler frequencies,
perform first one-way transmissions between a second plurality of pairs of antennas at selected second time intervals, and determine first one-way phase information for each pair of antennas participating in the first one-way transmissions,
determine distance information between the second plurality of pairs of antennas based on the determined first one-way phase information, antenna branch phase response data, and the absolute clock offset data
perform second two-way transmissions between a third plurality of the pairs of antennas at selected third time intervals, and determine second two-way phase information for each pair of antennas participating in the second two-way transmissions,
track the clock offset changes between the radio units using the second two-way phase information and the information regarding clock rates and Doppler frequencies,
perform second one-way transmissions between the second plurality of pairs of antennas at selected fourth time intervals, and determine one-way phase information for each pair of antennas participating in the second one-way transmissions, and
update the distance information between the second plurality of pairs of antennas based on the determined one-way phase information, the tracked clock offset changes, and the antenna branch phase response data.

An aspect of the invention is also related to a computer program product of claim 17.

The invention is based on a plurality of transmissions being carried out at selected time intervals and using differing numbers of pairs of antennas.

The transmissions may be utilized to determine differing types of phase information that may be used to determine selected information at selected time intervals to determine distance information without the need for performing transmissions between all antenna pairs of an arrangement at each time interval when the distance between them is to be determined, while still obtaining accurate distance information, such as with accuracy down to 0.1 mm.

Distance measurements based on two-way transmissions have an integer ambiguity of half wavelength, whereas distances determined based on one-way transmissions have integer ambiguity of one wavelength. The IA therefore has a periodicity of half wavelength for the two-way transmissions and one wavelength for one-way transmissions, and the IA may thus be easier to eliminate for one-way transmissions. Being able to determine distances with the one-way transmissions between the antennas is advantageous.

The determination of antenna branch phase delays/response, which is data that may be required for accurate distance determination, may in embodiments of the method of the invention be obtained as part of the procedure that is being carried out. Dedicated calibration circuitry for obtaining this data may thus not be needed. Separate calibration circuitry adds to costs of the systems and may typically interfere with the primary function of the system, such as positioning or communication.

The first time intervals may be longer than the second and third time intervals. The second time intervals may be longer than the third time intervals. The third time intervals may be longer than the fourth time intervals.

The first time interval may typically be between 1 s and 10 s. The first time interval may be determined by the hardware stability, such as by how fast the phase response of the active components in the antenna receive or transmit branches change. These changes may be tracked by the transmissions at the first time intervals.

The second time interval may be e.g. between 0.5 s and 2 s. The second time interval may be selected to maintain a correct IA in the distance or distances that are determined through the first one-way transmissions.

The third time interval may be e.g. between 20 ms and 150 ms. The third time interval may be determined by the stability of the oscillators of the radio units and the operation frequency. For a high-quality oven-controlled crystal or MEMS oscillators (OCXO) and radiofrequency (RF) operation frequencies of 5-6 GHz, the second time intervals could be in the order of 50 ms, such as between 20 ms and 100 ms. At 2.45 GHz frequency, a third time interval of e.g. 100 ms or 150 ms could be used.

The fourth time interval may be between 5 ms and 20 ms. The fourth time interval may be determined by the RF frequency and the rate of the changes occurring in the environment or the rate of changes in distances or velocities occurring between the pairs of antennas considered. For instance, at 5-6 GHz and considering an arrangement in connection with a warehouse with automatic guided vehicles (AGV), wherein AGVs are coupled to radio units and distances between antennas at different AGVs and/or antennas at AGVs and antennas of fixed radio units are to be determined, the fourth interval could typically be about 10 ms.

The present invention may enable determining distance data between pairs of antennas at selected time intervals using second one-way transmissions that occur more frequently (at the time intervals that the distance is to be determined) in combination with further transmissions (comprising at least two-way transmissions and first one-way transmissions) that occur less frequently.

Accuracy in distance determination may be obtained which is comparable to accuracy in distance determination using full two-way transmissions at the time intervals at which the distance is to be determined, while still using less resources (only the one-way transmissions necessary at these time intervals).

With a plurality of antennas and a plurality of distances being determined between pairs of antennas, positioning/locating and position tracking applications become possible.

An accuracy required for the clock offset data to be able to utilize only one-way transmissions in distance determination is extremely high, only a fraction of a picosecond if the radio frequency of operation is above 5 GHz. This problem has hindered the opportunity to use only one-way transmissions in distance determination. The invention, however, provides a method where one one-way transmission may be utilized in combination with accurate information regarding clock differences between radio units of antennas in a pair of antennas. This may be enabled through the realization that first two-way transmissions may be applied at the first time intervals and with the first plurality of pairs of antennas in combination with second two-way transmissions at the third time intervals with a third plurality of pairs of antennas to obtain accurate (absolute) clock offset data, whereby distances may be evaluated using only one-way transmissions at the fourth time intervals with the second plurality of pairs of antennas.

By performing the first two-way transmissions at the selected first time intervals, the first two-way transmissions may be utilized in the determination of absolute clock offset data, such that a related integer ambiguity (IA) in clock offset is resolved. The absolute clock offset data may refer to an absolute difference in time units (such as seconds) between the local clocks of the radio units associated with the pair of antennas that is being considered.

The second two-way transmissions may then be carried out at shorter, third time intervals, where it is known that the IA does not change between subsequent second two-way transmissions to track the clock offset changes. The second two-way transmissions may thus be used to update or check the related phase (at the measurement radio frequency) difference of the clocks, and as this is done at the third time intervals, may yield information on how the absolute clock offset has changed. The second two-way transmissions and tracked clock offset data may thus be used to track the clock offsets between the antennas at the selected third time intervals.

Obtained information regarding phase and time differences (clock offset data including changes therein) between the local oscillators (LOs) of the radio units may be used directly in positioning algorithms or in forcing a system to maintain a fixed time/phase relationship. Many wireless systems in the prior art may utilize a backhaul of the system for time synchronization of wireless units. In such systems, a separate stationary reference is always required for the synchronization. Yet, the backhaul is typically based on fiber-optic communication technology, which may at best reach nanosecond-level time synchronization accuracy.

Time synchronization accuracy of nanosecond time scale is not suitable for phase coherent transmission, where the required accuracy e.g. in cellular communication systems is at picosecond level. In addition, many of the prior art methods require line-of-sight between radio units to function properly. Even factors such as weather conditions could affect the accuracy of systems utilizing known methods of determining phase differences between local oscillators of radio units. With the present invention, however, clock offset data with under picosecond accuracy may obtained, without any backhaul and can be effectively used in the distance determination. As a plurality of radio units are used, the method may not be affected by whether there is a line-of-sight between the antennas or not. Only the capability to transmit and receive signals between the units is needed.

The present invention is thus well suited for terrestrial distance determination systems. Conversely, methods of the prior art are not accurate enough (regarding at least accuracy of clock offset data) for feasible determination of distances in terrestrial systems. Although some methods exist that may have better accuracy than the above-mentioned 1 nanosecond time synchronization accuracy, these are typically for fixed radio links between two radio units and are not suitable for synchronization of large number of radio units, some of them which may be mobile.

In one embodiment, the invention may enable the integration of co-operative multi-point transmissions (COMP) between wireless units, due to the high accuracy of clock offset and geometric phase length (between the transmitting and receiving antennas) data that may be obtained. Here, a communication service may be provided using COMP utilizing the same radio parts and antennas that are used for the clock offset data acquisition (those participating in the two-way transmissions). Frequencies used for the communication service and the determination of clock offset determination and tracking could differ somewhat and e.g. use neighboring frequency bands to avoid interference, yet the frequencies used could be close enough to each other that the cable phase length and clock offset information as well as the geometric path phase length obtained would be accurate enough for coherent COMP transmission and reception. For instance, the frequencies used for communication on one hand, and clock offset and path length determination on the other could be adjacent. A phase accuracy of 10-20 degrees at the carrier frequency used for communication may be sufficient for successful COMP.

The first one-way transmissions carried out at the second time intervals may be utilized together with antenna branch phase response, and absolute clock offset data, to determine the integer ambiguity in distance and then distances between the second plurality of pairs of antennas. The second one-way transmissions may then be carried out at the fourth time intervals and more frequently than the first one-way transmissions. The second one-way transmissions may be carried out using less frequencies (less resources) than the first one-way transmissions. The fourth time intervals may be selected so that it is known that the IA related to distance will not change between measurements at the fourth time intervals.

The second plurality of pairs of antennas may comprise all pairs of antennas between which distances are to be determined. In an arrangement or method where the distances between all antenna pairs are determined, the second plurality of pairs of antennas may comprise all pairs of antennas.

In one embodiment, an arrangement or method may be related to at least three fixed radio units and at least one movable/mobile radio unit. In this case, the method may be used to determine a position of each of the movable radio units with respect to at least a portion of the fixed units. Here, the antennas may also be considered as being either fixed or mobile.

Especially in the case of a plurality of mobile radio units, the second plurality of pairs of antennas may then comprise less pairs of antennas that could be considered in total involving all of the radio units, as distances between antennas of separate mobile radio units are not necessarily determined. Of course, if desired, also distances between antennas of mobile radio units may be determined (or, to be exact, antennas thereof).

If a second portion of the antennas are associated with movable radio units, the one-way transmissions may comprise transmissions where for pairs of antennas comprising at least one antenna in the second portion, the transmissions are sent from the antenna in the second portion and received by the other antenna in the pair. This way, phase measurement information (or any data determined therefrom) does not have to be sent from a movable unit to a processing unit. This may lead to a significant reduction in signal measurements at the mobile radio units. At the mobile radio units, it may be sufficient to receive transmissions for the purpose of clock offset data determination or tracking of the clock offset. This may lead to a reduction of required uplink measurement data by two orders of magnitude with high quality local oscillators.

A method or arrangement may also be related to only fixed radio units or radio units of which at least a portion are originally considered to be fixed, but which may move slightly, in which case the distances between the antennas may be determined to determine changes that occur. For example, this could be advantageous in structural health monitoring applications, where changes in distances between radio/antennas placed at selected locations in a building may indicate e.g. if maintenance operations are required. Another application area could be for instance fixed radio units located in light masts in a port. The masts may sway due to wind, and their positions may be continuously determined with reference to truly fixed reference units (e.g. at a light mast base.)

In one embodiment, a method may additionally comprise performing at least two sets of preliminary two-way transmissions between the first plurality of the pairs of antennas at an initiation step (two signals with the same frequency), and determining preliminary sets of two-way phase information for each pair of antennas participating in the preliminary two-way transmissions. Advantageously, in this embodiment the method may comprise determining the information regarding preliminary clock rates of radio units related to the first plurality of pairs of antennas based on the two sets of preliminary two-way phase information and/or determining of the information regarding Doppler frequencies for the first plurality of the pairs of antennas based on the two sets of preliminary two-way phase information.

The information regarding preliminary clock rates for the radio units related to the first plurality of pairs of antennas and/or the determining of the information regarding Doppler frequencies for the first plurality of the pairs of antennas may be determined or obtained using other methods.

The third plurality of pairs of antennas may comprise less pairs of antennas than the first or second plurality of pairs of antennas, wherein the third plurality of pairs of antennas comprises at least one antenna per radio unit. Utilizing fewer pairs of antennas in the third plurality of antennas, less resources are required, while still being able to determine the distances with the desired accuracy. It may thus be sufficient that transmissions and related data determination for the third plurality of antenna pairs only involve as few as one other radio unit per each radio unit, i.e. each radio unit may only have to report measurements of received phase for a minimum of one other radio unit, not for all other radio units or at least for less radio units as may be required relating to the first plurality of antenna pairs.

The second plurality of pairs of antennas may be equivalent to the first plurality of pairs of antennas or the second plurality of pairs of antennas may comprise less pairs than (preferably as subset of) the first plurality of pairs of antennas.

The first two-way transmissions and the first one-way transmissions may each be carried out utilizing at least three different frequencies with selected differences between the frequencies. The at least three frequencies may also span a selected frequency spacing, such as at least over 200 MHZ, more preferably over 500 MHZ. Yet, the transmissions may comprise one or more frequencies that are considered to be in at least two separate, non-overlapping frequency ranges, with said ranges having selected difference.

Advantageously a difference between a highest and lowest frequency may be preferably at least 200 MHZ, most preferably at least 500 MHz. The frequency ranges may be in completely different radio bands: for example, the higher range could be in the 5 GHZ RLAN band or in the new 6 GHz unlicensed bands whereas the lower range could be in 2.4 GHZ ISM band, allowing a frequency difference over 3 GHZ. Thus, the frequency ranges could be separated by e.g. 500 MHZ-5 GHz.

The second two-way transmissions and the second one-way transmissions may be carried out utilizing less frequencies than the first two-way transmissions and the first one-way transmissions. Only one frequency may be sufficient. The second two-way transmissions may thus be carried out using less resources than at least the first two-way transmissions and the second one-way transmissions may be carried out using less resources than at least the first one-way transmissions.

The first two-way transmissions and the first one-way transmissions are then advantageously only required to be performed less frequently than the lighter second two-way transmissions and second one-way transmissions. Performing of transmissions may also relate to the resources required in connection with the associated determination of data (e.g. phase information) that is carried out.

The first two-way transmissions and first one-way transmissions may be utilized to determine distance information and absolute clock offset data comprising resolved integer ambiguity.

The absolute clock offset data may be determined based on performing the first two-way transmissions by, for each pair of participating radio units,
a. performing first offset two-way transmissions between the radio units using a first offset signal comprising a selected first offset frequency,
b. determining first offset phase information regarding the first offset signals received at the radio units,
c. determining a first offset phase difference as a difference between the first offset phase information determined for each radio unit in the pair of radio units, and preferably correcting the first offset phase difference for the effects of antenna branch phase responses, clock rate difference and Doppler frequency,
d. performing second or subsequent offset two-way transmissions between the at least one pair of radio units using a second or subsequent offset signal comprising a selected second offset frequency or subsequent offset frequency,
e. determining second or subsequent offset phase information regarding the second or subsequent offset signals received at the radio units,
f. determining a second or subsequent offset phase difference, as a difference between the second or subsequent offset phase information determined for each radio unit in the pair of radio units, and preferably correcting the second or subsequent offset phase difference for the effects of antenna branch phase responses, clock rate difference and Doppler frequency,
g. determining a difference between the first offset phase difference and the second or subsequent offset phase difference, or a difference between the determined offset phase difference at the highest or lowest offset signal frequency and a subsequent offset phase difference,
h. determining at least one clock offset variable, being indicative of an approximated clock offset between the radio units in the pair of radio units, based on a difference determined at step g,
i. determining an estimated maximum error in the determined clock offset variable based at least on a maximum error of the first offset phase difference and a maximum error of the second or subsequent offset phase difference,
j. determining if the maximum error of the clock offset variable allows the clock offset to be unambiguously determined, by determining at least one set of possible clock offset values obtained through variation of the clock offset corresponding to variations of integer numbers of half cycle periods at at least one of the first or subsequent offset frequencies, said set of possible clock offset values being limited by the estimated maximum error in the determined clock offset variable,
k. repeating the steps d-j using a subsequent selected offset frequency that differs from the first offset frequency by an amount that is more than the difference between the first offset frequency and the second or previously used offset frequency, if it is determined that the clock offset cannot be unambiguously determined.

The determination of clock offset data may remain essentially unaffected by slow movement of the units, e.g. sway in light masts due to small scale of error in the determined clock offset. The movement of one or more radio units may be taken into account and compensated for via a model and/or measurements to normalize or equalize the frame of reference for the clock offset determination measurements.

The present invention may allow determination or evaluation of distances between antennas with narrow instantaneous bandwidth of used frequencies in the transmitted signals (e.g. a bandwidth of 40 MHz or even as low as 10 kHz). The present invention provides a method and arrangement which may be inexpensive to implement, whereby inexpensive narrow band receivers may be utilized.

Due to the narrow operating bandwidth of the present invention, the system may operate at frequency bands/ranges where high transmission powers are allowed, enabling better range and accuracy than e.g. UWB-based time synchronization systems, which are required to operate at very low transmission powers. Bands that are feasible with the present invention may be e.g. 5 GHZ RLAN (enabling transmission power of 100 mW or even 1W) or WIA band (enabling transmission power of 400 mW). Therefore, the power used for transmission of one or more signals (e.g. primary and/or auxiliary signals) may be over tens of mW, such as over 20 mW, over 50 mW, or over 80 mW.

With the present invention, it may also be easy to fit the utilized narrow bands between e.g. wifi network channels.

Preferably, at least a portion of the signals are transmitted as broadcasts, such that a transmitted signal is received at at least a portion of the non-transmitting antennas.

One of the radio units may be set as a reference radio unit in embodiments of the invention by referring the clock offsets of all the other radio units to the reference radio unit.

When a plurality of radio units are used to determine a plurality of clock offsets via embodiments of the present invention, time and/or resources may be saved. In traditional systems with a plurality of radio units, a measurement is conducted in relation to each radio link, i.e. each pair of radio units separately sends a signal to each of the remaining radio units. For instance, in a system or arrangement with 10 radio units, 45 two-way signals should be utilized, whereby a total of at least 90 transmissions should be conducted. With the present invention, however, clock offsets between each of the radio units may be determined with only 10 transmissions, which may greatly reduce resources and a time duration that is required for the measurements and/or transmissions.

Each of the transmitting radio units may in some embodiments transmit at least one signal within a predetermined time slot and in predetermined order.

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

The previously presented considerations concerning the various embodiments of the method may be flexibly applied to the embodiments of the arrangement mutatis mutandis, and vice versa, as being appreciated by a skilled person.

### BRIEF DESCRIPTION OF THE DRAWINGS

Next the invention will be described in greater detail with reference to exemplary embodiments in accordance with the accompanying drawings, in which:

FIG. 1 depicts one exemplary arrangement according to an embodiment of the invention,

FIG. 2 shows a flow chart of a method according to one embodiment of the invention,

FIG. 3 illustrates one exemplary scenario for determining clock offset data based on the first two-way transmissions,

FIG. 4 shows one example of transmissions performed in an embodiment of the invention involving four radio units as an exemplary use case scenario,

FIG. 5 shows one exemplary embodiment of a radio unit,

FIG. 6 shows one further exemplary embodiment of a radio unit,

FIG. 7 depicts one exemplary use case involving 9 radio units each with 4 separate antennas, and

FIG. 8 illustrates measurement frames and time slots according to one example.

### DETAILED DESCRIPTION

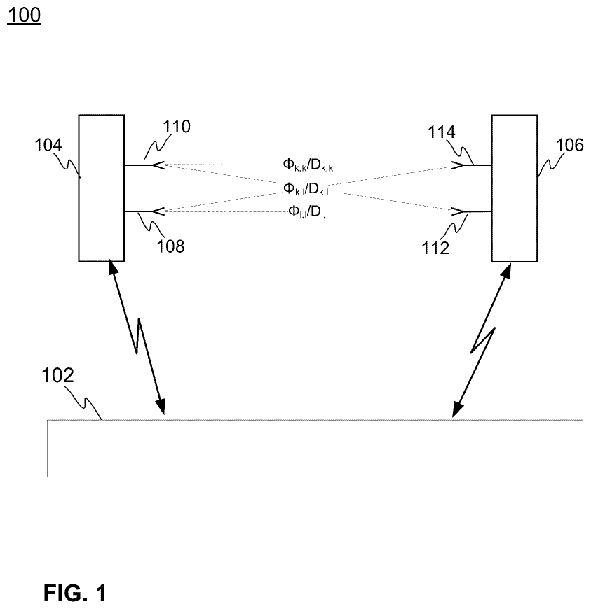

FIG. 1 shows an arrangement 100 according to one embodiment of the invention. The arrangement 100 comprises at least two radio units, here a first radio unit 104 and a second radio unit 106. Each radio unit comprises at least one antenna, with the first radio unit of FIG. 1 comprising a first antenna 108 and second antenna 110, and the second radio unit 106 comprising at least a first antenna 112 and a second antenna 114.

The arrangement additionally comprises or is in connection with at least one processor 102. The radio units 104, 106 may comprise a processing unit 102 and/or radio units 104, 106 may be in wired or wireless connection with a processing unit 102. The processor 102 may receive data from the radio units 104, 106.

The processor 102 and radio units 108, 110 may be powered using for instance power-over-Ethernet (POE), direct mains supply, batteries, solar panels, or mechanical generators (e.g. in wind turbine blades).

The arrangement is configured to determine at least one distance between pairs of antennas 108, 110, 112, 114. For instance, the arrangement 100 of FIG. 1 may be configured to determine distances between the 4 different pairs of antennas that may be made, referred to in the figure as e.g. distance D_{k,l} (corresponding to phase length Φ_{k,l}) when labeling the antennas of a radio unit as first antenna k and second antenna l.

Transmission and timing of signals as well as information determined based on the transmitted signals will be discussed further below.

It may be noted that not all antennas of a radio unit are required to transmit signals, nor even have capability to do so. For instance, if a radio unit 104, 106 comprises four antennas 108, 110, 112, 114, out of which two antennas are involved in the transmitting, there are still a sufficient number of equations to solve for all the unknowns.

The antennas 108, 110, 112, 114 may transmit respective signals each in their own time slot. However, it is possible that two or more antennas in a radio unit transmit in one time slot simultaneously using frequency division (different frequencies transmitted by different antennas) or code division (each antenna uses a different scrambling code). It is also possible that multiple antennas of a radio unit transmit simultaneously exactly the same signal if there is no risk of them interfering with each other e.g on the virtue of spatial separation.

Each of the signals transmitted may be a radiofrequency (RF) signal, which is preferably a sine wave, but can be any signal with a known modulation. The duration of the signals may for instance be between 10 and 10 000 μs depending on e.g. the length of the distances between the antenna/radio units, the time intervals between different transmissions, and/or the quality of local oscillators comprised in the radio units 104, 106. A duration of a signal may for instance be about 100 μs.

Typically, the signal frequency is different from the local oscillator frequency and the phase measurement often occurs in digital baseband using e.g. fast fourier transform. Essentially, this is equivalent to measuring the phase against the local oscillator that can, for simplicity, be understood to operate at the signal frequency.

In some cases, due to hardware and bandwidth limitations, the frequencies of the used signals are considered to be comprised in separate non-overlapping frequency ranges, each corresponding to a separate transmission or reception chain with a given bandwidth. In this case, a frequency range may for instance encompass a maximum bandwidth of 50 Hz-100 kHz, preferably 10-100 kHz in the case of only one signal transmitted in said range or 5-100 MHZ, preferably 10-50 MHZ, such as e.g. 40 MHz in the case of a plurality of signals being transmitted in said range.

In the case of separate frequency ranges, a difference between e.g. a first frequency range and a second frequency range may be at least 150 MHZ, preferably at least 200 MHZ, most preferably at least 500 MHZ. The difference could even be over 3 GHZ, for example, where the two frequency ranges lie in completely different radio bands, such as the 2.4 GHz ISM, 5 GHz RLAN/ISM or 6 GHz unlicensed bands.

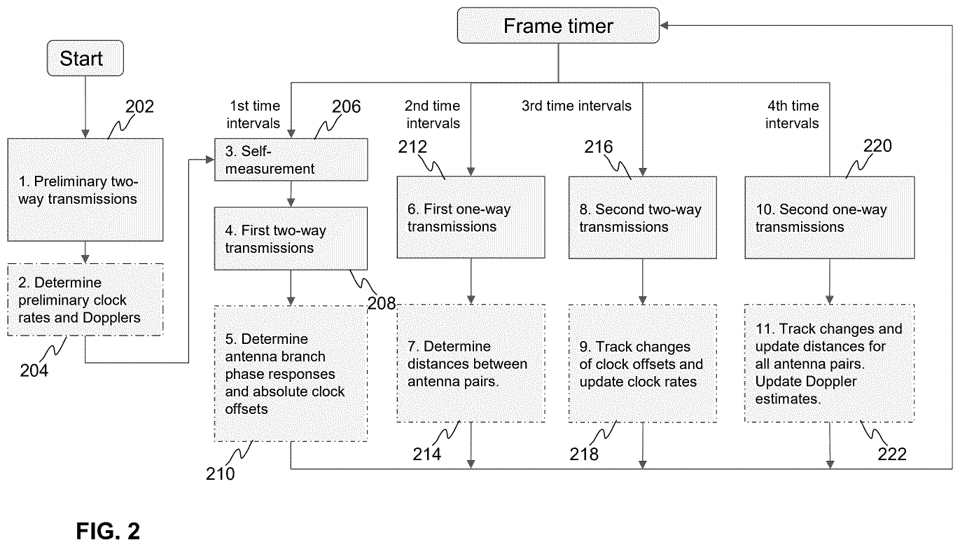

FIG. 2 shows a flow chart of a method according to one embodiment of the invention, where the performing of measurement/transmission frames at the selected time intervals is illustrated.

At 202, the method may comprise performing at least two sets of preliminary two-way transmissions between the first plurality of the pairs of antennas at an initiation step. This initiation step is not, however, mandatory. The initiation step may be performed only once in the method, or at selected times, being however less frequent than the fourth time intervals.

The two sets of preliminary two-way transmissions may comprise transmitting, with each of the transmitting antennas 108, 110, 112, 114, at least first and second preliminary signals, wherein the first and second preliminary signals have the same frequency, i.e. each antenna transmits at least one pair of the same signal twice. The preliminary signals may be transmitted by each participating antenna in a predetermined time slot. The first and second preliminary two-way transmissions may be carried out e.g. within 1-2 milliseconds.

The preliminary two-way transmissions may comprise two-way transmissions between selected pairs of antennas (and yet over each radio link that has antennas comprised in the pairs of antennas between which distances are to be determined), such that each radio unit 104, 106 associated with an antenna comprised in the first plurality of pairs of antennas has at least one antenna 108, 110, 112, 114 participating in the preliminary two-way transmissions. The signals may be received at the non-transmitting antennas, e.g. at all of the antennas of the non-transmitting radio units, but at at least one antenna of a non-transmitting radio unit. It is sufficient to determine phase information for only one receiving antenna.

The preliminary two-way transmissions may also comprise further transmissions, such as e.g. each participating antenna transmitting at least third and fourth preliminary signals, wherein the third and fourth preliminary signals comprise the same frequency. Frequencies used for the preliminary two-way transmissions may all be comprised in a frequency range that is considered as narrow, such as e.g. between 10-50 MHz.

The initiation step may also comprise determining preliminary sets of two-way phase information for each pair of antennas participating in the preliminary two-way transmissions.

The initiation step may thereafter also comprise determining 204 information regarding preliminary clock rates for the first plurality of antennas based on the two sets of preliminary two-way phase information and determining of the information regarding Doppler frequencies for the first plurality of the pairs of antennas based on the two sets of preliminary two-way phase information.

Self-measurements may be performed 206 via at least a portion of the antennas 108, 110, 112, 114 at selected first time intervals. The first time intervals may be e.g. every 1-10s. The self-measurements may be carried out by all of the antennas of an arrangement or at least by the antennas comprised in the first plurality of pairs of antennas. Self-measurement phase information may then be determined for each antenna participating in the self-measurements.

The antennas 108, 110, 112, 114 performing the self-measurements are configured to transmit at least one signal that is received at the other antennas comprised in the same radio unit 104, 106. The self-measurements may also be expressed as being performed by radio units 104, 106, such that each radio unit participating in the self-measurements transmits a signal via each of its antennas, said signal being received by all other non-transmitting antennas of the radio unit. Alternatively, self-measurement may comprise transmission of a signal by an antenna by its radio unit and reception of a sample of the transmitted signal being received at the same (transmitting) antenna, which will be discussed further below.

Regarding self-measurements where signals are received by non-transmitting antennas in the same radio unit, for each radio unit 104, 106 participating in the self-measurements, referring to a radio unit i comprising antennas k and l, each unit measures the following quantities during a self measurement at frequency fₘ:

$${φ}_{ii}^{kl} ( {f}_{m} ) = - {θ}_{i}^{Tk} ( {f}_{m} ) - {θ}_{i}^{Rl} ( {f}_{m} ) - {ϕ}_{i}^{kl} ( {f}_{m} ) , k \neq l \qquad ( 1 )$$

where φᵢᵢ^{kl}(fₘ) is the measured self phase (phase of the signal at reception) for radio unit i for transmission through antenna k and reception through antenna l, θᵢ^{Tk} is the phase length of the transmit antenna branch k (from DAC to antenna), θᵢ^{Rl} is the phase length of the receive antenna branch l (from antenna to ADC), and ϕᵢ^{kl} is the phase length of the coupling between antennas k and l at measurement frequency fₘ. For a radio unit with four antennas, this yields 12 measurements per radio unit 104, 106, each described by equation (1).

The coupling phase terms ϕᵢ^{kl} can be understood to be very stable. They may be determined using a calibration procedure that will be described later herein; for now, they can be assumed as known. The branch terms θᵢ^{Tk} and θᵢ^{Rl} are not as stable, as the antenna branches contain active electronic components, such as amplifiers and mixers. However, they may be considered to remain constant over time scales of seconds or minutes.

First two-way transmissions may be performed 208 between the first plurality of the pairs of antennas at the first time intervals, and first two-way phase information for each pair of antennas may be determined. The first two-way transmissions may be carried out between all radio links that are involved in the distance determination, such that all radio units 104, 106 associated with an antenna comprised in the first plurality of pairs of antennas has the respective antennas 108, 110, 112, 114 participating in the first two-way transmissions.

“Phase information” may refer to the phase of any received signal with respect to the local oscillator of the receiving radio unit as it is received. “Two-way phase information” may refer to phase information that is determined regarding a signal that is transmitted by a first antenna (of a first radio unit) and received at a second antenna (of a second radio unit) and phase information that is determined regarding a corresponding signal with the same frequency that is transmitted by the second antenna and received by the first antenna.

A phase difference may refer to the difference between the phases determined by the two-way phase information.

The first two-way transmissions may be carried out using a plurality of frequencies (enough that the associated IA (or correct clock offset value from a set of possible clock offset values) may be determined unambiguously). For instance, at least two frequencies in two separate frequency ranges may be used, with frequency ranges as discussed herein elsewhere.

The self-measurements and first two-way transmissions may occur simultaneously or at differing times, in separate time slots.

Antenna branch phase response data for the antennas of the first plurality of pairs of antennas and absolute clock offsets between the radio units associated with the first plurality of pairs of antennas bay be determined 210 using the self-measurement phase information, the first two-way phase information, and the information regarding clock rates and Doppler frequencies. The clock offset also comprises information regarding an IA (estimate) for the clock offsets.

Considering a pair of radio units i and j two sets of pairwise measurements can be made, the first where radio unit i transmits over antenna k and radio unit j receives over antenna l, and the second where radio unit j transmits over antenna l and radio unit i receives over antenna k:

$${φ}_{ij}^{kl} ( {t}_{i} , {f}_{m} ) = {θ}_{i}^{C} ( {t}_{i} , {f}_{m} ) - {θ}_{i}^{Tk} ( {f}_{m} ) - {ϕ}_{ij}^{kl} ( {t}_{i} , {f}_{m} ) - {θ}_{j}^{Rl} ( {f}_{m} ) - {θ}_{j}^{C} ( {t}_{i} , {f}_{m} ) \qquad ( 2 )$$

$${φ}_{ji}^{lk} ( {t}_{j} , {f}_{m} ) = {θ}_{j}^{C} ( {t}_{j} , {f}_{m} ) - {θ}_{j}^{Tl} ( {f}_{m} ) - {ϕ}_{ij}^{kl} ( {t}_{j} , {f}_{m} ) - {θ}_{i}^{Rk} ( {f}_{m} ) - {θ}_{i}^{C} ( {t}_{j} , {f}_{m} ) \qquad ( 3 )$$

where φᵢⱼ^{kl}(tᵢ, fₘ) is the phase of the received signal measured by radio unit j with respect to its own clock at time of transmission tᵢ by radio unit i, θᵢ^{C}(tᵢ) and θⱼ^{C}(tᵢ) are the phases of the local oscillators at time tᵢ, θ^{T} and θ^{R} are as before, and ϕᵢⱼ^{kl}(tᵢ) is the phase length of the link between the phase centers of radio node i antenna k and radio node j antenna l. As all quantities are always at frequency fₘ this dependency is omitted from the following equations. Note that, as the channel is reciprocal, ϕᵢⱼ^{kl}=ϕⱼᵢ^{lk}.

One of the instrumental terms of each unit in, say θᵢ^{T0} in equations (2) and (3), or the phase length of the transmit branch 0, can be normalized to zero. That means that the clock solution for any radio node is referred not to LO oscillator output, but rather to antenna 0 phase center on transmission. With such an agreement, all the other instrumental terms of a given radio node should be understood so that of θᵢ^{C}(tᵢ)−θᵢ^{Tk} is the transmission phase at phase center of antenna k and θᵢ^{Rk}+θᵢ^{C}(tⱼ) is the local oscillator phase at the phase center of antenna k in an imaginary but equivalently performing radio unit where all the receiving antenna (RX) chain components, including the sampler, would be placed at that phase center.

Forming the difference, and assuming the clocks have constant rate

$$( \frac{{d}^{2} {θ}^{C}}{{dt}^{2}} = 0 )$$

and that Doppler dϕᵢⱼ^{kl}/dt is constant:

$${φ}_{ij}^{kl} ( {t}_{i} ) - {φ}_{ji}^{lk} ( {t}_{j} ) = \qquad ( 4 )$$

$$2 [ {θ}_{i}^{C} ( {t}_{i} ) - {θ}_{j}^{C} ( {t}_{i} ) ] + \frac{d ( {θ}_{i}^{C} - {θ}_{j}^{C} )}{dt} Δ t + \frac{d {ϕ}_{ij}^{kl}}{dt} Δ t - ( {θ}_{i}^{Tk} - {θ}_{i}^{Rk} ) + ( {θ}_{j}^{Tl} - {θ}_{j}^{Rl} )$$

where Δt=tⱼ−tᵢ.

The arrangement 100 is configured to obtain information regarding clock rates and Doppler frequencies for the first plurality of pairs of antennas. This information may be obtained from an external source or may be considered as pre-known.

Yet, in one embodiment, if the clock rate differences and Dopplers are not known, these may be determined through the arrangement being configured to perform at least two sets of preliminary two-way transmissions between the first plurality of the pairs of antennas at an initiation step. Preliminary sets of two-way phase information may be determined for each pair of antennas participating in the preliminary two-way transmissions.

Here, the clock rate differences and Dopplers may be obtained by solving the following group of equations (T is time between the two sets of preliminary two-way transmissions):

$${φ}_{i j}^{k l} ( {t}_{i} + T ) - {φ}_{i j}^{k l} ( {t}_{i} ) = \frac{d ( {θ}_{i}^{C} - {θ}_{j}^{C} )}{dt} T - \frac{d {ϕ}_{i j}^{kl}}{dt} T \qquad ( 5 )$$

$${φ}_{j i}^{l k} ( {t}_{j} + T ) - {φ}_{j i}^{l k} ( {t}_{j} ) = - \frac{d ( {θ}_{i}^{C} - {θ}_{j}^{C} )}{dt} T - \frac{d {ϕ}_{i j}^{kl}}{dt} T \qquad ( 6 )$$

After solving the clock rates and the Doppler frequencies and setting a reference clock θ₀^{C}=0, i.e. selecting one of the radio units as a reference unit, all the other clock phases (or equivalently, local oscillator phases), the phase lengths of the antenna branches can be solved from equation groups (1) and (4). It should be noted that true phases, rather than cyclic phases, should be used to solve the equations. As an example, if we have four antennas per radio unit, and two radio units, equation group (1) yields 24 equations and group (4) yields 16 equations. The number of unknowns, in this case, is 15. By forming the equations and using e.g. a Gaussian elimination, it turns out that the number of linearly independent equations in these two groups is also 15, and the unknowns can be solved.

The measurements and solutions described above are for a single frequency point fₘ. They can be repeated (or done simultaneously) for any number of frequency points, as described in what follows. This makes it possible to measure the clock differences (not the local oscillator phase differences, but the clock differences in time units) between radio units as well as branch phase responses over frequency and delays in all the antenna branches, which may be used to determine the true (non-cyclic) phases needed for the linear equations.

The absolute clock offset data may be determined based on performing the first two-way transmissions by, for each pair of participating radio units,
a. performing first offset two-way transmissions between the radio units using a first offset signal comprising a selected first offset frequency,
b. determining first offset phase information regarding the first offset signals received at the radio units,
c. determining a first offset phase difference as a difference between the first offset phase information determined for each radio unit in the pair of radio units,
d. performing second or subsequent offset two-way transmissions between the at least one pair of radio units using a second or subsequent offset signal comprising a selected second offset frequency or subsequent offset frequency,
e. determining second or subsequent offset phase information regarding the second or subsequent offset signals received at the radio units,
f. determining a second or subsequent offset phase difference, as a difference between the second or subsequent offset phase information determined for each radio unit in the pair of radio units,
g. determining a difference between the first offset phase difference and the second or subsequent offset phase difference, or a difference between the determined offset phase difference at the highest or lowest offset signal frequency and a subsequent offset phase difference,
h. determining at least one clock offset variable, being indicative of an approximated clock offset between the radio units in the pair of radio units, based on a difference determined at step g,
i. determining an estimated maximum error in the determined clock offset variable based at least on a maximum error of the first offset phase difference and a maximum error of the second or subsequent offset phase difference,
j. determining if the maximum error of the clock offset variable allows the clock offset to be unambiguously determined, by determining at least one set of possible clock offset values obtained through variation of the clock offset corresponding to variations of integer numbers of half cycle periods at at least one of the first or subsequent offset frequencies, said set of possible clock offset values being limited by the estimated maximum error in the determined clock offset variable,
k. repeating the steps d-j using a subsequent selected offset frequency that differs from the first offset frequency by an amount that is more than the difference between the first offset frequency and the second or previously used offset frequency, if it is determined that the clock offset cannot be unambiguously determined.

With the above, the utilized offset frequencies may be selected to comprise frequencies that may be considered to reside in separate frequency ranges.

First one-way transmissions may be performed 212 between the second plurality of pairs of antennas at selected second time intervals. The second time intervals may be e.g. every 0.5-2s. The first one-way transmissions may be used to determine first one-way phase information. The second plurality of pairs of antennas may participate in the first one-way transmissions, such that regarding each associated pair of radio units 104, 106, an antenna comprised in the second plurality of pairs of antennas either transmits or receives at least one signal from another radio unit. Selected radio units may be selected to perform the transmitting. For instance, it may be selected that mobile radio units only receive.

The time intervals considered, especially the first and second time intervals may be varied e.g. at every cycle if it is determined that it is advantageous. The time intervals, or the procedures carried out at the specified time intervals, may e.g. be carried out on demand. For example, if the procedure to be carried out at the fourth time interval is missed for several times in a row due to the channel being occupied by some other system and the distance IA slips one or more cycles, such slips may be accounted for by suitable selection of the other time intervals. In 3D positioning involving a plurality of antennas, such slips may be detected from the residuals in the position solution, and could be utilized to run the procedure related to the second time interval when needed. This applies also for the procedure to be carried out at the first time intervals, which may also be run on demand.

For pure determination of distance between two antennas only, there is no way of detecting such IA slips and regular running of the procedures at first and second time intervals may be required.

The first one-way transmissions may be carried out using a plurality of frequencies, enough that the associated IA (or correct distance value from a set of possible distance values) may be determined unambiguously. For instance, at least two frequencies in two separate frequency ranges may also be used in this case.

Distance information between the second plurality of pairs of antennas based on the determined first one-way phase information is then determined 214 based on determined clock offsets, branch phase responses, and first one-way phase information. The determination of distance information may involve solving an integer ambiguity, i.e. the uncertainty in the number of full wavelengths, related to the determined distances.

When the clock offsets, clock phases as well as branch phase responses are measured through the first two-way transmissions, the true geometric phases of the radio paths between the antenna phase centers can be determined through the one-way transmissions (first and second, used separately) and determined one-way phase information by rearranging equation (2):

$${ϕ}_{i j}^{k l} ( {t}_{i} , {f}_{m} ) = {θ}_{i}^{C} ( {t}_{i} , {f}_{m} ) - {θ}_{i}^{T k} ( {f}_{m} ) - {φ}_{i j}^{k l} ( {t}_{i} , {f}_{m} ) - {θ}_{j}^{R l} ( {f}_{m} ) - {θ}_{j}^{C} ( {t}_{i} , {f}_{m} ) \qquad ( 7 )$$

The actual lengths of the links (referring to distance between the antennas) can be estimated based on the geometric phase and knowledge of the number of wavelengths between the phase centers of the antennas. The number of wavelengths can be obtained from geometric phase measurements performed over a sufficient number of frequencies where an integer ambiguity is resolved. This will be discussed later in more detail.

Sufficient approximations for the Doppler estimates needed in equation (4) can now be tracked by computing the differences between consecutive geometric phases:

$$\frac{d {ϕ}_{i j}^{k l}}{dt} = \frac{{ϕ}_{i j}^{k l} ( {t}_{i} , {f}_{m} ) - {ϕ}_{i j}^{k l} ( {t}_{i} - Δ t , {f}_{m} )}{Δ t} \qquad ( 8 )$$

where Δt is the time interval between consecutive second one-way phase measurements. Similarly, an appropriately accurate approximation for the clock rate estimates can be obtained from the clock offsets:

$$\frac{d {θ}_{i}^{C}}{dt} = \frac{{θ}_{i}^{C} ( {t}_{i} ) - {θ}_{i}^{C} ( {t}_{i} + Δ t )}{Δ t} \qquad ( 9 )$$

In order for equations (8) and (9) to be feasible, the Doppler and clock rates have to be small enough to avoid phase ambiguity between the measurement intervals. If this is not the case, a more sophisticated estimator, such as Kalman filter, may have to be used, initialized with the values obtained from equations (5) and (6).

As explained above, the clock phases θᵢ^{C}(tᵢ, fₘ) and the geometric path length ϕᵢⱼ^{kl}(tᵢ, fₘ) can be determined from equations (1)-(4) and (7), respectively, for one measurement frequency. Such a single frequency phase value does not alone allow the determination of the absolute clock offset tᵢ of the radio unit i with respect to the reference unit in seconds or the absolute distance Dₖₗ between antennas k and l. However, they have simple relations:

$${θ}_{i}^{C} ( {t}_{i} , {f}_{m} ) = ( {τ}_{i} {f}_{m} + N ) \cdot 2 π \qquad ( 10 )$$

$${ϕ}_{i j}^{k l} ( {t}_{i} , {f}_{m} ) = ( \frac{{D}_{k l}}{c} {f}_{m} + M ) \cdot 2 π \qquad ( 11 )$$

where c is the speed of light and θᵢ^{C}(tᵢ, fₘ) and ϕᵢⱼ^{kl}(tᵢ, fₘ) are given in radians. Therefore, if we could determine M and N (the integer ambiguity), we would be able to derive τᵢ and Dₖₗ even from single phase measurements. The way to determine those is to make phase measurements at different frequencies, let us say at a first and second selected frequency, frequencies f₁ and f₂. From equations (10) and (11) and omitting the time relationship

$${θ}_{i}^{C} ( {f}_{1} ) - {θ}_{i}^{C} ( {f}_{2} ) = [ {τ}_{i} ( {f}_{1} - {f}_{2} ) + {N}_{1} - {N}_{2} ] \cdot 2 π \qquad ( 12 )$$

$${ϕ}_{i j}^{k l} ( {f}_{1} ) - {ϕ}_{i j}^{k l} ( {f}_{2} ) = [ \frac{{D}_{k l}}{c} ( {f}_{1} - {f}_{2} ) + {M}_{1} - {M}_{2} ] \cdot 2 π \qquad ( 13 )$$

where N₁ and N₂ (or M₁ and M₂) correspond to the integer ambiguity at frequencies f₁ and f₂, respectively.

Rearranging,

$${N}_{1} - {N}_{2} = \frac{{θ}_{i}^{C} ( {f}_{1} ) - {θ}_{i}^{C} ( {f}_{2} )}{2 π} - ( {f}_{1} - {f}_{2} ) {τ}_{i} \qquad ( 14 )$$

$${M}_{1} - {M}_{2} = \frac{{ϕ}_{i j}^{k l} ( {f}_{1} ) - {ϕ}_{i j}^{k l} ( {f}_{2} )}{2 π} - \frac{{f}_{1} - {f}_{2}}{c} {D}_{k l} \qquad ( 15 )$$

As N and M must be integers, only a set of discrete values for τᵢ and Dₖₗ are possible given the phase measurements, each corresponding to one value of N₁−N₂ or M₁−M₂. These may be considered as sets of possible clock offset values and sets of possible distance values. The difference between such consecutive discrete values are 1/(f₁−f₂) for τᵢ and c/(f₁−f₂) for Dₖₗ. If we have a large a priori uncertainty for the values of τᵢ and Dₖₗ, we have to use a small difference f₁−f₂ so that only one possible value would fit the uncertainty range. Different values for f₁ and f₂ can be used in order to determine τᵢ and Dₖₗ as their uncertainties are naturally different. The maximum values for the frequency difference are:

$$\vert {f}_{1} - {f}_{2} \vert < \frac{1}{Δ {τ}_{i}} \qquad ( 16 )$$

$$\vert {f}_{1} - {f}_{2} \vert < \frac{c}{Δ {D}_{k l}} \qquad ( 17 )$$

where Δτᵢ and ΔDₖₗ are the a priori uncertainties in the clock offset and the distance, respectively. For example, the uncertainty in τᵢ can be e.g. 1 microsecond that is easily achievable with a synchronization sequence commonly used in wireless communication. We should therefore have at most one possible value for τᵢ in the known range. This can be achieved by setting the measurement frequencies so that |f₁−f₂|<1 MHZ. Similarly, if we know, for example, that the distance is less than 100 meters, we need to have only one possible value for Dₖₗ in the range 0-100 m. To achieve that, |f₁−f₂| should be below 3 MHz.

The values for τᵢ and Dₖₗ obtained by using the measurements at frequencies f₁ and f₂ to solve equations (14) and (15) and fitting the a priori uncertainty range, designated here as the clock offset variable τᵢ¹² and distance variable Dₖₗ¹² also have an uncertainty which arises from the uncertainty in the measurement of both the clock phase Δθᵢ^{C} and the geometric phase Δϕᵢⱼ^{kl}:

$$Δ {τ}_{i}^{12} = \frac{Δ {θ}_{i}^{C}}{π \cdot \vert {f}_{1} - {f}_{2} \vert} \qquad ( 18 )$$

$$Δ {D}_{k l}^{12} = \frac{{Δϕ}_{i j}^{kl} \cdot c}{π \cdot \vert {f}_{1} - {f}_{2} \vert} \qquad ( 19 )$$

derived from equations (14) and (15) with the assumption that total uncertainty in the phase difference (in the nominator) is twice the uncertainty of a single phase measurement. This uncertainty is based on the estimated maximum error in the determined phase information, which may be used to obtain estimated maximum error in a determined phase difference. The estimated maximum errors in phase-related information may then limit the set of possible distance values or set of possible clock offset values through the corresponding error margins.

From equations (10) and (11), we can see that the possible values of τᵢ (or Dₖₗ) that match the measured clock phase of θᵢ^{C}(f₁) (or geometric phase ϕᵢⱼ^{kl}(f₁)) at frequency f₁ repeat at intervals of 1/f₁ (or c/f₁). If the uncertainty in τᵢ¹² or Dₖₗ¹² from equations (18) or (19) is smaller than these repetition intervals, that is,

$$\frac{Δ {θ}_{i}^{C}}{π \cdot \vert {f}_{1} - {f}_{2} \vert} < \frac{1}{{f}_{1}} \qquad ( 20 )$$

$$\frac{{Δϕ}_{i j}^{kl} \cdot c}{π \cdot \vert {f}_{1} - {f}_{2} \vert} < \frac{c}{{f}_{1}} \qquad ( 21 )$$

we are able to determine N or M and obtain the final estimate for τᵢ or Dₖₗ from equations (10) and (11). That is, in this case the likely clock offset value or likely distance value may be unambiguously selected from the set of possible values (i.e. there will be only one value left that fits the determined error margins). However, if the uncertainty is larger and the likely clock offset value or likely distance value cannot be unambiguously selected, we can repeat the measurements at a subsequent selected frequency, such as third frequency f₃ that is further away from the first frequency f₁ than the second frequency f₂ is, i.e., |f₁−f₃|>|f₁−f₂|. However, the difference |f₁−f₃| cannot be arbitrarily large, as equations (16) and (17) must hold to prevent ambiguity in phase. By using equations (16)-(19), we can set the necessary conditions for the distance of the new frequency f₃:

$$\vert {f}_{1} - {f}_{3} \vert < \frac{π \cdot \vert {f}_{1} - {f}_{2} \vert}{Δ {θ}_{i}^{C}} \qquad ( 22 )$$

$$\vert {f}_{1} - {f}_{3} \vert < \frac{π \cdot \vert {f}_{1} - {f}_{2} \vert}{{Δϕ}_{i j}^{k l}} \qquad ( 23 )$$

This process can be repeated until the conditions (20) and (21) are met (with the new subsequent selected frequency f₃, f₄, . . . substituted for f₂).

As an example, if the error in phase measurement is 5 degrees and we use |f₁−f₂|=1 MHZ, we get from equation (18) maximum uncertainty for τᵢ of approximately 30 nanoseconds. However, if our highest measurement frequency is f₁=5.8 GHZ, we see from equation (20) that the uncertainty should be under 1/5.8 GHZ=170 picoseconds. Therefore, we have to find a third frequency, which is at most (equation 16) ˜30 MHz distant from f₁, say 5.77 GHz. Assuming the same phase measurement accuracy (5 degrees), we obtain a new measurement of θᵢ^{C}(f₃) with an uncertainty of roughly 1 nanosecond. This is still worse than the required accuracy of 170 picoseconds, so we find a still new frequency fulfilling the condition (16). As the condition now would be |f₁−f₄|<1 GHZ, we can safely select e.g. f₄=5.4 GHz. This would now give the uncertainty for τᵢ of 55 picoseconds, sufficient to use equation (10) to obtain the final estimate for τᵢ. Note that the accuracy of this measurement (from equation 18, with f₂=0) is already 5 picoseconds.

In a practical implementation, frequencies f₁, f₂, f₃ could be transmitted in a single frequency band (or first frequency range) of only 30 MHz bandwidth and the fourth frequency could be transmitted in a separate band (second frequency range), either simultaneously or sequentially. In a low-cost transmitter with a very narrow bandwidth, all the four frequencies could be transmitted in a fast sequence (e.g. on the order of 200 microseconds). However, a reasonably good oscillator would still be required to allow accurate phase differences to be formed over separate transmissions.

The discussion of selection of second or subsequent frequencies may also be considered in terms of selection of second or subsequent frequency ranges. With a narrowband device, with a possibility to send only one frequency at a time, the consideration of second or subsequent frequencies does not have to incorporate consideration of frequency ranges. In a more broadband system with a bandwidth of e.g. 40 MHZ, two or more of the signals, with differing frequencies, may be transmitted simultaneously in one range. In this case the further away frequencies should be transmitted in a different range. A system that has two parallel broadband transceivers could be utilized, whereby it could be possible to send and receive signals in two ranges simultaneously. And finally, a still more expensive system could be employed, where the bandwidth is e.g. 500 MHZ. Then all signals could be sent in one large frequency range. Thus, the concept of frequency range may depend on the hardware implementation.

Second two-way transmissions may be performed 216 between the third plurality of the pairs of antennas (preferably comprising less pairs of antennas than the first or second plurality) at selected third time intervals. Second two-way phase information is determined for each pair of antennas participating in the second two-way transmissions. The second two-way transmissions may be carried out using only one frequency.

The above discussed integer ambiguity determination protocol for clock offsets may be carried out via the first two-way transmissions at the selected first time intervals, and the arrangement 100 may be configured to track the clock offset between the e.g. first 104 and second radio unit 106 via the second two-way transmissions at the selected third time intervals such that the IA does not change. The second two-way phase information may be used to determine phase differences to repeatedly determine clock offset information being indicative of a change in clock offset between the first and second radio unit.

In order to determine the clock offset changes, it is sufficient to measure the clock offset phase on one or two frequencies (to be resilient against a possible strong fading event on one frequency). Since the antenna branch phase responses have been measured using a two-way measurement over multiple frequencies and solving the equations (1)-(4), an update for the clock phases between the radio units can be calculated from

$${θ}_{j}^{C} ( {t}_{i} ) - {θ}_{i}^{C} ( {t}_{i} ) = \frac{1}{2} [ - {φ}_{i j}^{k l} ( {t}_{i} ) + {φ}_{j i}^{l k} ( {t}_{j} ) + \frac{d ( {θ}_{i}^{C} - {θ}_{j}^{C} )}{dt} Δ t + \frac{d {ϕ}_{i j}^{k l}}{dt} Δ t - ( {θ}_{i}^{T k} - {θ}_{i}^{R k} ) + ( {θ}_{j}^{T l} - {θ}_{j}^{R l} ) ] \qquad ( 24 )$$

obtained by rearranging equation (4). As the branch phase responses are known for all antennas, it is sufficient to use only a single pair of antennas between any two radio units to obtain their mutual clock offset phases of θⱼ^{C}(tᵢ)−θᵢ^{C}(tᵢ). It is clear that when this is done between different pairs of radio units, it is possible to determine and track the clock phase θⱼ^{C}(tᵢ) of any radio unit against a reference unit (the clock offset of which is set to zero). One should note that for some units, especially for all the mobile units, it is advantageous to make this two-way, one or two frequency measurement with only one fixed radio unit, since the amount of measurement data to be transmitted from the mobile unit is thereby minimized.

The repetition interval, the third time interval, of the clock offset update measurement, should be small enough that the clock offset phase error does not exceed a suitable value, say e.g. 7 degrees. 7 degree accuracy is sufficient for distance determination at an accuracy of 1 millimeter at 5 GHZ frequency. A typical value for the third interval is 20-50 ms for a high-quality oven-controlled MEMS oscillator.

The clock offset changes may thus be tracked 218 between the radio units based on the second two-way phase information and the information regarding Doppler frequencies. Clock rates may be updated by using the clock offset changes.

In the above treatment, it has been assumed that the antenna coupling phase terms ϕᵢ^{kl}(fₘ) in equation (1) are known. They can be measured with a calibration measurement, where two radio units 104, 106 are at known positions and orientations with respect to each other. For example, if we have four antennas 108, 110, 112, 114 in both radio units, there will be 16 known distances between the antenna phase centers. The distances correspond to known phase lengths ϕᵢⱼ^{kl}(fₘ) at each frequency fₘ used in the calibration measurement. The process of determining the antenna coupling terms ϕᵢⱼ^{kl}(fₘ) could be as follows:
1) Set ϕᵢ^{kl}(fₘ)=0
2) Using equations (1-3) and (7), compute ϕᵢⱼ^{kl}(fₘ) and compare them with the known values (known from the distances between antenna phase centers that will be known in the calibration procedure)
3) Adjust ϕᵢ^{kl}(fₘ) and go back to (2) until a reasonable match, e.g. within 5-10 degrees RMS over all ϕᵢⱼ^{kl}(fₘ) has been achieved.

Second one-way transmissions are performed 220 between the second plurality of the pairs of antennas at the selected fourth time intervals. Second one-way phase information is then determined for each pair of antennas participating in the second one-way transmissions. The second one-way transmissions may be carried out using only one frequency.

As already set forth relating to the absolute clock offset, when the integer ambiguity for both clock offset and distance has been determined (referring to the procedures carried out in connection with the first and second time intervals), it is sufficient to only track changes to both the clock offsets and distance, assuming IA remains known, to be able to provide updated clock offset information and ultimately, updated distance information.

Similarly to that discussed in connection to the clock offset, once the IA has been determined for all the distances between the second plurality of pairs of antennas, equation (7) may be used and new one-way measurements at one, two or a small number of frequencies to get new estimates for the geometric phases ϕᵢⱼ^{kl}(tᵢ, fₘ). In principle, one frequency is sufficient if there is no risk of significant fast fading. If we have a line-of-sight between the antennas, fading should be small and one frequency should work very well. The repetition interval for the one-way distance update measurement, the fourth time interval, should be small enough that there is no risk of the geometric phase estimate to slip one whole cycle, i.e. 2π, or more. A typical value for moving vehicles, such as cars or automated guided vehicles, would be e.g. 10 milliseconds.

One should note that the rate and Doppler estimates, needed in equation (24), can be obtained easily from the observed rate of change in the updated clock offset phase and geometric phase information, as shown by equations (8) and (9).

Distance information between the second plurality of pairs of antennas is thus updated 222 based on the determined second one-way phase information, the tracked clock offset changes and the antenna branch phase response data. At least some of the determined distances thus correspond to those already determined at step 214, but can be updated/tracked at step 222. The distances updated at 222 may also comprise or refer to information related to relative positions of antennas.

In one possible embodiment, it may be advantageous to determine the distance information in a radio unit associated with a mobile antenna. In this case, a separate (fixed) processor 102 may send data regarding the clock offset and antenna branch phase response information regularly to a radio unit associated with a mobile antenna, where the radio unit would also have its own respective processing unit 102 to solve the distances as per equation (7), based on its own measurements of the distance phases. If the fixed processor 102 also reports position information for the fixed radio units, the mobile radio unit processor can also determine position information of the mobile unit.

The processing of information may also be carried out in complex domain where the argument of the complex number represents the considered phase. The equations considered herein, for example, may as well be written in the complex domain, as will be understood by the skilled person. Processing of information may be conducted in different order than that which is proposed here.

An order of how radio unit transmissions are allocated into time slots may vary between super frames, which will be introduced further below. For example, the order can be reversed for every other super frame. This naturally affects how the equations are written. All possible variations can be understood to be in the scope of the present disclosure.

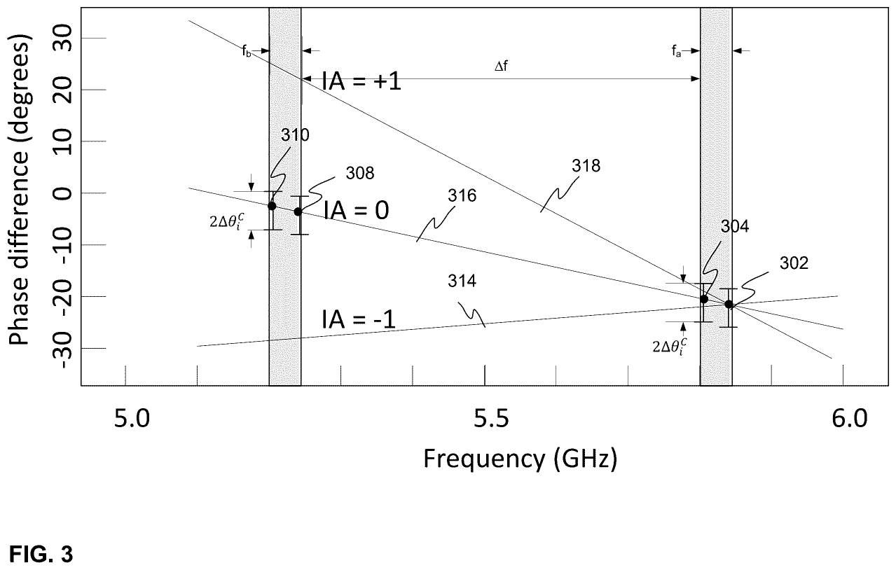

FIG. 3 illustrates how the first two-way transmissions may be used to determine absolute clock offset information, where a likely clock offset value may be selected from a set of possible clock offset values. FIG. 3 shows, on a graph of determined offset phase difference as a function of transmitted signal frequency, possible determined offset phase differences and lines corresponding to a set of possible clock offset values in one use case scenario according to one embodiment of the invention. Here, two frequency ranges are considered, with two offset signals in each range.

The e.g. numbers, lines, and calculated values of FIG. 3 are merely exemplary and are intended as visual aids in describing the invention. The exact depicted values might be possible e.g. in a case where the absolute clock offset is only about 200 picoseconds. However, the principle remains the same for any clock offset.

Depicted points 302 and 304 may correspond to a first offset phase difference and second offset phase difference, respectively. In this example, first and second offset signals (having frequencies of f₁ and f₂) have therefore been transmitted. The first and second offset signals may be considered to be comprised in a first frequency range fₐ. The exemplary first frequency range fₐ spans a frequency range of about 40 MHz.

Points 308 and 310 may correspond to a third offset phase difference and fourth offset phase difference respectively. In this example, third and fourth offset signals (with frequencies of f₃ and f₄) have therefore been transmitted, which may be considered as being comprised in a second frequency range f_{b}. The exemplary second frequency range f_{b} spans a frequency range of about 40 MHz.

First and second frequency ranges fₐ, f_{b} may be equivalent in bandwidth or the bandwidths may differ from each other. Yet, the first and second frequency ranges are advantageously both narrow enough to enable the use of narrow band receivers (cf. WiFi receivers) or even Internet-of-Things receivers operating on a coin battery.

The difference Δf between the first frequency range fₐ and second frequency range f_{b} is about 550 MHz in the example of FIG. 3. The frequencies of the primary signals can be larger than the frequencies of the auxiliary signals or the frequencies of the primary signals can be smaller than the frequencies of the auxiliary signals, yet there is advantageously a difference Δf between the frequencies/frequency ranges that is sufficiently large that a likely clock offset value can be determined.

In some embodiments of the invention, signals may be transmitted also in third and possibly fourth and subsequent narrow bands in addition to the first band or first frequency range fₐ and second band or second frequency range f_{b}.

A purposive selection of frequency ranges may be made or offset signals may be transmitted without selection or determination of the frequency ranges during selection of the offset signal frequencies, with the previously discussed selection of subsequent frequencies at step k ultimately leading to the transmitted offset signals being considered as comprising frequencies in two separate non-overlapping frequency ranges.

The set of possible clock offset values may be graphically understood to correspond to integer ambiguity lines, when considering offset phase difference as a function of transmission frequency. This is illustrated in FIG. 3. The set of possible IA values (the value of N) or set of possible clock offset values are shown as integer ambiguity lines that cross the first offset phase difference 302. The line with a slope corresponding to the determined clock offset variable with IA=0 (the best preliminary match), which also determines the value for N₁−N₂, is shown as 316. The neighboring possibilities are IA=+1 (318) and IA=−1 (314), corresponding to clock offset differences of half a cycle period (at the measurement radio frequency) larger or smaller, respectively. All of these fit the error margins of 2Δθᵢ^{C} around the first and second offset phase difference measurements shown as error bars and are therefore part of the set of possible IA values or possible clock offset values after transmission of the first and second offset signals.

The integer ambiguity line IA=0 may be determined as the line that crosses two of the determined offset phase differences or a line that has the best least-squares fit to the offset phase difference points.

In the example of FIG. 3, it may be observed that the likely clock offset values are not limited to one possible clock offset value after transmission of the first and second offset signals, and third and fourth offset signals or frequencies (corresponding to offset phase differences 308 and 310) may be selected to further limit the set of possible clock offset values.

In FIG. 3, it is seen that the likely integer ambiguity value is one which corresponds to an integer ambiguity line that fits the measurement error 2Δθᵢ^{C}, which limits the set of possible clock offset values, and which in this example would be IA=0, corresponding to line 316.

The above description relating to FIG. 3 and clock offset may also apply to the distance determination based on the first one-way transmissions. The determined first one-way phase information may accordingly be presented on a graph of determined phase as a function of transmitted signal frequency, showing possible determined one-way phase information and lines corresponding to a set of possible distance values. The transmission frequencies and number of transmissions used may also similarly be selected such that the likely distance value may be unambiguously selected from the set of possible distance values.

The procedure of steps a.-k. discussed previously may be adapted in the case of the distance determination based on the first one-way transmissions with the exception that it is now a set of possible distance values that is determined based on one-way phase information with corresponding error values discussed previously. The following differences may be applied for distance determination: instead of performing offset two-way transmissions, distance one-way transmissions are performed; instead of determining offset phase information, distance phase information is determined regarding the distance signals received at the radio units; instead of determining offset phase difference, the determined distance phase is only corrected for the clock offset between the radio units in the pair and the related antenna branch phase responses; instead of determining a difference between the offset phase differences, the differences between corresponding distance phases are determined; instead of determining a clock offset variable, a distance variable is determined; instead of determining an estimated maximum error in the determined clock offset variable, an estimated maximum error in the distance variable is determined by using the corresponding maximum errors in the distance phases; instead of determining at least one set of possible clock offset values, at least one set of possible distance values is obtained through variation of the distance corresponding to variations of integer number wavelengths at at least one of the first or subsequent utilized frequencies.

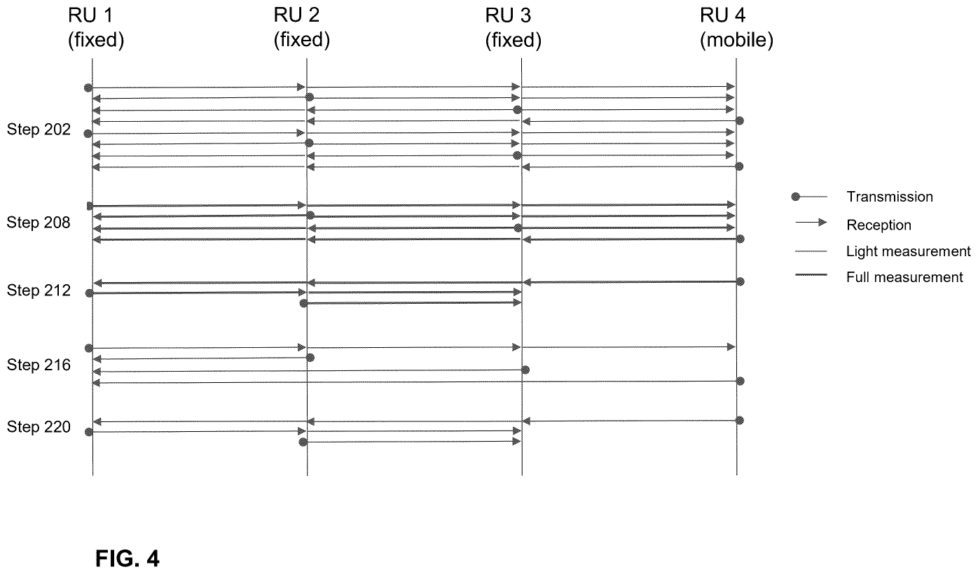

FIG. 4 shows one example of how transmissions may be performed in an embodiment of the invention involving four radio units RU1, RU2, RU3, RU4, of which one (RU4) may be a mobile radio unit. FIG. 3 does not depict nor consider separate antennas of the radio units.

FIG. 4 depicts transmissions and receptions by the radio units RU1, RU2, RU3, RU4 that are carried out at the steps 202, 208, 212, 216, and 220, referring to the method steps introduced in FIG. 2.

FIG. 4 also introduces steps 202, 216, and 220 as being carried out as light measurements, while steps 208 and 212 comprise full measurements. The terms “light” and “full” refer to the number of different frequencies at which transmissions are executed. Less frequencies are utilized in the light measurements than in the full measurements. As disclosed previously, the full measurements may involve at least four different frequencies (or enough frequencies to be able to select a likely clock offset value and/or distance value, i.e. resolve an integer ambiguity), while the light measurements may involve one to a few different frequencies. Of course, all steps may also be carried out with e.g. more than four frequencies each, but in order to save resources, for certain steps, fewer frequencies may suffice.

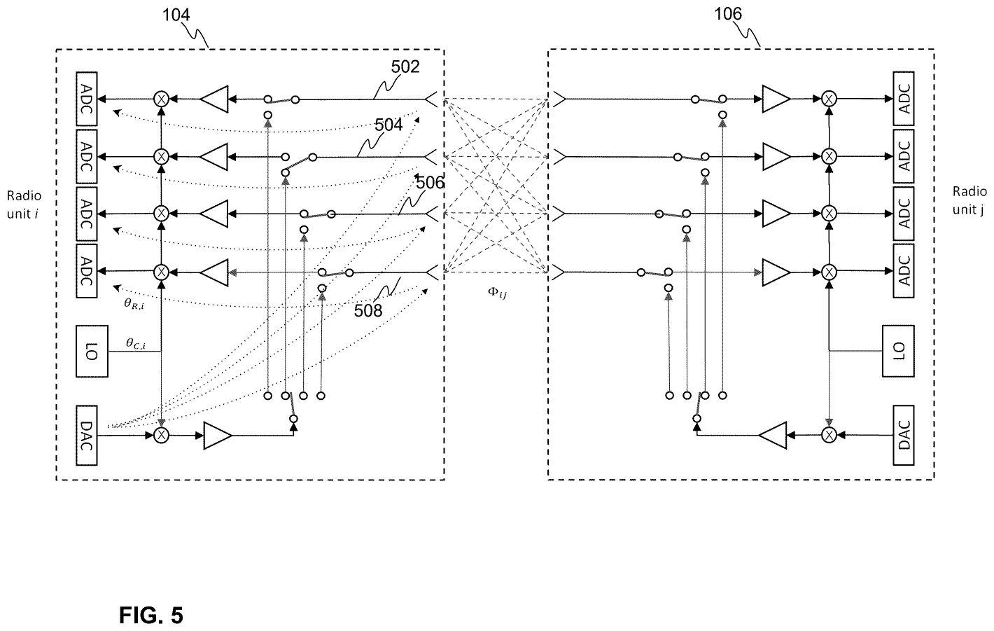

FIG. 5 shows one exemplary embodiment of radio units 104, 106. Here, the radio units each comprise four antennas 502, 504, 506, 508 each (with labeling of the antennas depicted only for the first radio unit 104). The antennas are integrated with the radio units. The dotted lines marked as Φ_{i,j} show the different pairs of antennas that may be considered and the related distances between them.

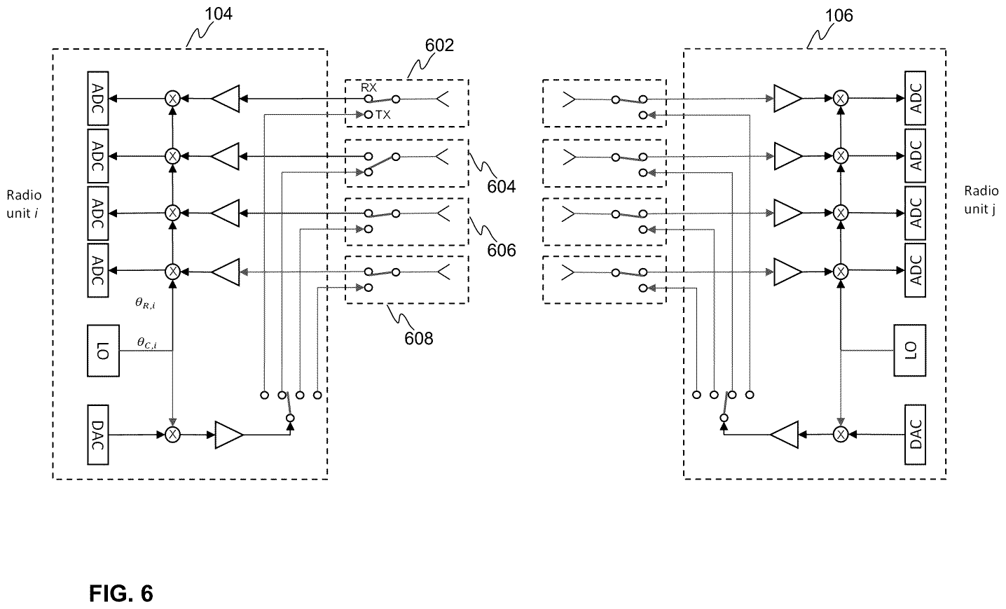

FIG. 6 shows one further exemplary embodiment of radio units 104, 106. In this example, radio units also each comprise four antennas each. The antennas are, however, each provided as a separate antenna, here antennas 602, 604, 606, 608 (with labeling of the antennas depicted only for the first radio unit 104). The distances that may be evaluated are similar to that depicted in FIG. 5, i.e. the possible pairs of antennas that may be considered involve all antennas 602, 604, 606, 608 of the radio units 104, 106.

One possible way for self-calibration of such a radio unit (referring to performing the self-measurements) is to use the leakage through the switch in an antenna instead of the signal coupled to the other antennas.

During transmission through the antenna, also during the self-measurement, the switch is in the transmit (TX) position. When the antenna is used to receive a signal from other radio units, the switch is in receive (RX) position. As the switch is a small device with excellent stability over time, it can be expected that the coupling term through the switch ϕᵢ^{k}(fₘ) (for antenna k) remains constant.

In such an arrangement, and setting θᵢ^{Tk}(fₘ) to zero, equation (1) reduces to

$${φ}_{i i}^{k} ( {f}_{m} ) = - {θ}_{i}^{R k} ( {f}_{m} ) - {ϕ}_{i}^{k} ( {f}_{m} ) \qquad ( 25 )$$

Setting of θᵢ^{Tk}(fₘ) of each antenna to zero means that the clock of the radio unit is separately normalized to each antenna phase center on transmission. So, instead of one clock, the radio unit has effectively an imaginary clock for each transmission antenna. Let us assume that there are two such radio units measuring/receiving transmissions from each other (i.e. performing the two-way transmissions), both using only one antenna (k at radio unit i and l at radio unit j) for such measurement, equation (4) with the Doppler and clock rate terms determined as explained above, reduces essentially to

$${φ}_{i j}^{k l} ( {t}_{i} ) - {φ}_{j i}^{l k} ( {t}_{j} ) = 2 [ {θ}_{i k}^{C} ( {t}_{i} ) - {θ}_{j l}^{C} ( {t}_{i} ) ] - ( - {θ}_{i}^{R k} ) + ( - {θ}_{j}^{R l} ) \qquad ( 26 )$$

where θᵢ^{Rk} and θⱼ^{Rl} can be simply obtained from the self-measurements and equation (8), assuming that the coupling terms ϕᵢ^{k}(fₘ) have been calibrated. Note that the clock phase terms have an additional index for the antenna to which the clock has been normalized. It can be seen that the clock offset between radio units i and j can be determined for the antenna pair kl.

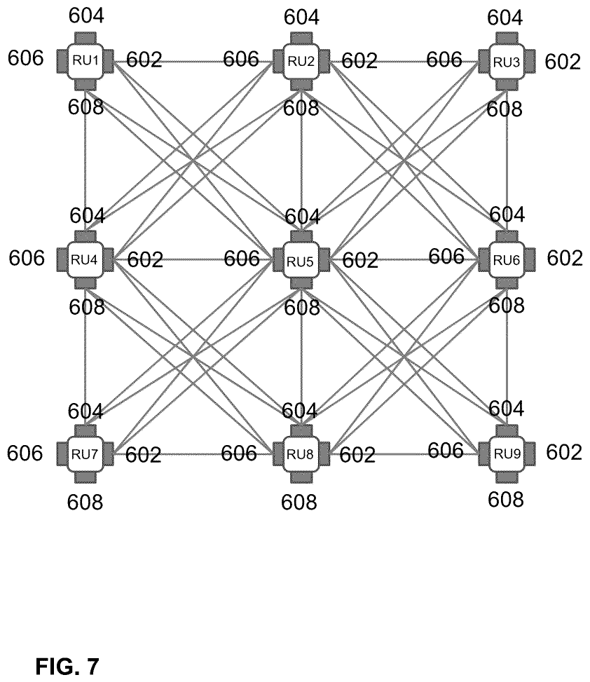

FIG. 7 depicts one exemplary use case involving 9 radio units RU1, RU2, RU3, RU4, RU5, RU6, RU7, RU8, RU9 each with 4 separate external antennas 602, 604, 606, 608. The distances between pairs of antennas that may be determined are depicted. Here, not all antenna pairs that may theoretically be obtained with the depicted hardware are possible to be involved in the pairs of antennas between which distances are determined.

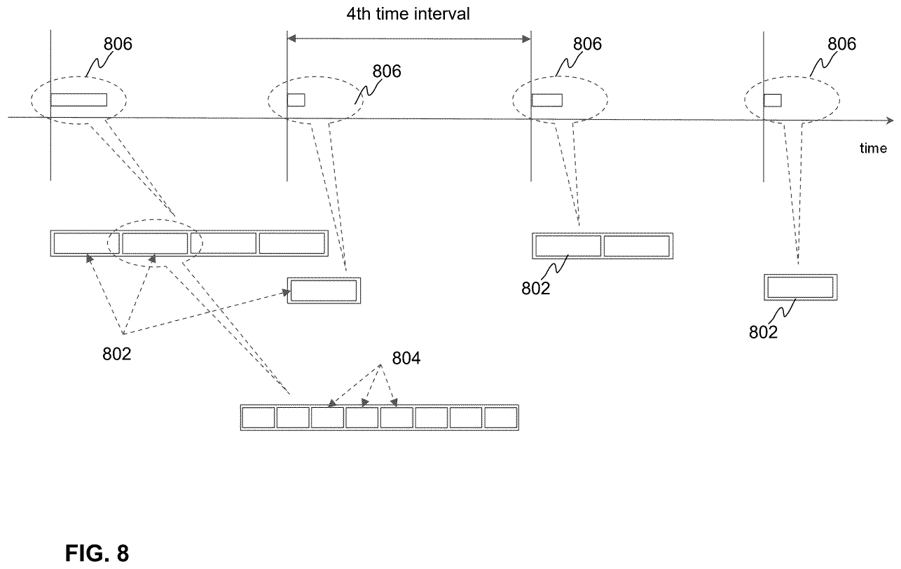

FIG. 8 illustrates measurement frames 802 and time slots 804 according to one example. The measurement frames 802 each comprise a selected number of time slots 804. The number of time slots 804 in each frame 802 may differ, but typically relating to one arrangement 100, the number of time slots in each frame may correspond to the number of radio units 102, 104.

The measurement frames 802 may be arranged into super frames 806. Each super frame 806 may comprise a selected number of frames 802, wherein each super frame may comprise a differing number of frames 802. Multiple frames could be used, for example, for measurements at different frequencies so that the local oscillators in the radio unit have time to settle to the new frequencies. The super frames, despite having different numbers of measurement frames, occur regularly with the starting times of each super frame occurring at the fourth time intervals.

The invention has been explained above with reference to the aforementioned embodiments, and several advantages of the invention have been demonstrated. It is clear that the invention is not only restricted to these embodiments, but comprises all possible embodiments within the spirit and scope of inventive thought and the following patent claims.

The features recited in dependent claims are mutually freely combinable unless otherwise explicitly stated.

1. A method for determining at least one distance between pairs of antennas, each antenna relating to a radio unit, the method comprising
performing self-measurements via at least a portion of the antennas at selected first time intervals, and determining self-measurement phase information for each antenna participating in the self-measurements,
performing first two-way transmissions between a first plurality of the pairs of antennas at the first time intervals, and determining first two-way phase information for each pair of antennas participating in the first two-way transmissions,
obtaining information regarding clock rates and Doppler frequencies for the first plurality of pairs of antennas,
determining antenna branch phase response data for the antennas of the first plurality of pairs of antennas and absolute clock offset data between the radio units associated with the first plurality of pairs of antennas using the self-measurement phase information, the first two-way phase information, and the information regarding clock rates and Doppler frequencies,
performing first one-way transmissions between a second plurality of pairs of antennas at selected second time intervals, and determining first one-way phase information for each pair of antennas participating in the first one-way transmissions,
determining distance information between the second plurality of pairs of antennas based on the determined first one-way phase information, antenna branch phase response data, and the absolute clock offset data
performing second two-way transmissions between a third plurality of the pairs of antennas at selected third time intervals, and determining second two-way phase information for each pair of antennas participating in the second two-way transmissions,
tracking the clock offset changes between the radio units based on the second two-way phase information and the information regarding clock rates and Doppler frequencies,
performing second one-way transmissions between the second plurality of pairs of antennas at selected fourth time intervals, and determining second one-way phase information for each pair of antennas participating in the second one-way transmissions, and
updating the distance information between the second plurality of pairs of antennas based on the determined second one-way phase information, the tracked clock offset changes and the antenna branch phase response data.

2. The method of claim 1, wherein the first time intervals are longer than the second and third time intervals, preferably wherein the second time intervals are longer than the third time intervals, and the third time intervals are longer than the fourth time intervals.

3. The method of claim 1, wherein the first time interval is 1-10 s, the second time interval is 0.5-2 s, the third time interval is 20-150 ms, and the fourth time interval is 5-20 ms.

4. The method of claim 1, wherein the first two-way transmissions and first one-way transmissions are utilized to determine distance information and absolute clock offset data comprising resolved integer ambiguity.

5. The method of claim 1, wherein transmitting radio units transmit at least one signal within a predetermined time slot and in predetermined order.

6. The method of claim 1, wherein the second plurality of pairs of antennas comprises all pairs of antennas between which distances are to be determined.

7. The method of claim 1, wherein at least a first portion of the antennas are fixed, and at least a second portion of antennas are movable.

8. The method of claim 1, wherein the method additionally comprises performing at least two sets of preliminary two-way transmissions between the first plurality of the pairs of antennas at an initiation step, and determining preliminary sets of two-way phase information for each pair of antennas participating in the preliminary two-way transmissions.

9. The method of claim 8, wherein the method comprises determining the information regarding preliminary clock rates for the radio units associated with the first plurality of pairs of antennas based on the two sets of preliminary two-way phase information.

10. The method of claim 8, wherein the method comprises determining the information regarding Doppler frequencies for the first plurality of the pairs of antennas based on the two sets of preliminary two-way phase information.

11. The method of claim 1, wherein the third plurality of pairs of antennas comprises less pairs of antennas than the first or second plurality of pairs of antennas, wherein the third plurality of pairs of antennas comprises at least one antenna per radio unit.

12. The method of claim 1, wherein the third plurality of pairs of antennas comprises at least one antenna per each radio unit that is associated with antennas comprised in the first plurality of antennas.

13. The method of claim 1, wherein the first two-way transmissions and the first one-way transmissions are each carried out utilizing at least three different frequencies with selected differences between the frequencies, preferably wherein the at least three frequencies span a selected frequency range, such as at least over 200 MHz, more preferably over 500 MHz.

14. The method of claim 1, wherein the second two-way transmissions and the second one-way transmissions are carried out utilizing less frequencies than the first two-way transmissions and the first one-way transmissions, advantageously only one to two frequencies.

15. The method of claim 1, wherein the absolute clock offset data is determined based on performing the first two-way transmissions by, for each pair of participating radio units,
a. performing first offset two-way transmissions between the radio units using a first offset signal comprising a selected first offset frequency,
b. determining first offset phase information regarding the first offset signals received at the radio units,
c. determining a first offset phase difference as a difference between the first offset phase information determined for each radio unit in the pair of radio units,
d. performing second or subsequent offset two-way transmissions between the at least one pair of radio units using a second or subsequent offset signal comprising a selected second offset frequency or subsequent offset frequency,
e. determining second or subsequent offset phase information regarding the second or subsequent offset signals received at the radio units,
f. determining a second or subsequent offset phase difference, as a difference between the second or subsequent offset phase information determined for each radio unit in the pair of radio units,
g. determining a difference between the first offset phase difference and the second or subsequent offset phase difference, or a difference between the determined offset phase difference at the highest or lowest offset signal frequency and a subsequent offset phase difference,
h. determining at least one clock offset variable, being indicative of an approximated clock offset between the radio units in the pair of radio units, based on a difference determined at step g,
i. determining an estimated maximum error in the determined clock offset variable based at least on a maximum error of the first offset phase difference and a maximum error of the second or subsequent offset phase difference,
j. determining if the maximum error of the clock offset variable allows the clock offset to be unambiguously determined, by determining at least one set of possible clock offset values obtained through variation of the clock offset corresponding to variations of integer numbers of half cycle periods at at least one of the first or subsequent offset frequencies, said set of possible clock offset values being limited by the estimated maximum error in the determined clock offset variable,
k. repeating the steps d-j using a subsequent selected offset frequency that differs from the first offset frequency by an amount that is more than the difference between the first offset frequency and the second or previously used offset frequency, if it is determined that the clock offset cannot be unambiguously determined.

16. An arrangement for determining at least one distance between pairs of antennas, the arrangement comprising at least one processor and at least two radio units, each associated with at least one antenna, wherein the arrangement is configured to:
perform self-measurements via at least a portion of the antennas at selected first time intervals, and determine self-measurement phase information for each antenna participating in the self-measurements,
perform first two-way transmissions between a first plurality of the pairs of antennas at the first time intervals, and determine first two-way phase information for each pair of antennas participating in the first two-way transmissions,
obtain information regarding clock rates and Doppler frequencies for the first plurality of pairs of antennas,
determine antenna branch phase response data for the antennas of the first plurality of pairs of antennas and absolute clock offset data between the radio units associated with the first plurality of pairs of antennas using the self-measurement phase information, the first two-way phase information, and the information regarding clock rates and Doppler frequencies,
perform first one-way transmissions between a second plurality of pairs of antennas at selected second time intervals, and determine first one-way phase information for each pair of antennas participating in the first one-way transmissions,
determine distance information between the second plurality of pairs of antennas based on the determined first one-way phase information, antenna branch phase response data, and the absolute clock offset data
perform second two-way transmissions between a third plurality of the pairs of antennas at selected third time intervals, and determine second two-way phase information for each pair of antennas participating in the second two-way transmissions,
track the clock offset changes between the radio units using the second two-way phase information and the information regarding clock rates and Doppler frequencies,
perform second one-way transmissions between the second plurality of pairs of antennas at selected fourth time intervals, and determine second one-way phase information for each pair of antennas participating in the second one-way transmissions,
update the distance information between the second plurality of pairs of antennas based on the determined one-way phase information, the tracked clock offset changes, and the antenna branch phase response data.

17. A computer program product comprising program code means adapted to execute the method items of claim 1 when run on the processor of an arrangement.
